(19) United States
(12) Patent Application Publication
(10) Pub. No.: US 2020/0227812 A1
(43) Pub. Date: Jul. 16, 2020

(54) MULTI-SYSTEM INTEGRATED ANTENNA

(71) Applicants: Comba Telecom Technology (Guangzhou) Ltd., Guangzhou Guangdong (CN); Comba Telecom Systems (China) Ltd., Guanzhou Guangdong (CN); Tianjin Comba Telecom Systems Ltd., Tianjin (CN)

(72) Inventors: Shanqiu Sun, Guangzhou, Guangdong (CN); Qiang Wang, Guangzhou, Guangdong (CN); Mingchao Li, Guangzhou, Guangdong (CN); Liwen Huang, Guangzhou, Guangdong (CN); Weiwei Jiang, Guangzhou, Guangdong (CN)

(73) Assignees: Comba Telecom Technology (Guangzhou) Ltd., Guangzhou, Guangdong (CN); Comba Telecom Technology (Guangzhou) Ltd., Guangzhou, Guangdong (CN); Comba Telecom Systems (China) Ltd., Guangzhou, Guangdong (CN); Comba Telecom Systems (China) Ltd., Guangzhou, Guangdong (CN); Tianjin Comba Telecom Systems Ltd., Tianjin (CN); Tianjin Comba Telecom Systems Ltd., Tianjin (CN)

(21) Appl. No.: 16/326,600

(22) PCT Filed: May 23, 2017
(86) PCT No.: PCT/CN2017/085504

§ 371 Date: Feb. 19, 2019

(30) Foreign Application Priority Data
Aug. 18, 2016 (CN) 201610695996.1

(51) Int. Cl. H01Q 1/24; H01Q 15/14; H01Q 21/06

(52) U.S. Cl. CPC H01Q 1/246; H01Q 21/061; H01Q 15/14

(57) ABSTRACT

The present application provides a multi-system integrated antenna, including reflective plate, intelligent antenna array and base station antenna array both disposed on reflective plate. Intelligent antenna array is at lower end of reflective plate, and includes intelligent antenna subarrays each composed of plurality of intelligent antenna array elements. Base station antenna array includes first base station antenna array elements and second base station antenna array elements. First base station antenna array elements are located at upper end of reflective plate, and second base station antenna array elements are embedded in gaps of intelligent antenna array elements, and enclose intelligent antenna array elements of two adjacent intelligent antenna subarrays. Intelligent antenna array gaps are fully used by second base station antenna array element, increasing base station antenna array elements without increasing reflective plate size. Antenna gain, and facilitating antenna miniaturization is achieved.

### TECHNICAL FIELD

The present application relates to the field of communications, and in particular, to a multi-system integrated antenna.

### BACKGROUND ART

With increase of mobile communication network standards, multiple communication standards coexist. In order to optimize resource allocation, save station addresses and antenna feeder resources, reduce the difficulty of property coordination, and reduce investment costs, the system integrated antenna of the co-station and co-address is gradually becoming the first choice for operators to build a network.

At present, the multi-system integrated antenna selected by operators usually is an effective integration of an intelligent antenna system (1880˜1920 MHz, 2010˜2025 MHz, and 2575˜2635 MHz) and a base station antenna system (880˜960 MHz and 1710˜1880 MHz) in a radome. The commonly used antenna integration method is as shown in the patent CN101465473B (shown in FIG. 1), in which the intelligent antenna array 1 and the base station antenna array 2 are mounted on the reflective plate 3, wherein the intelligent antenna array 1 is composed of four columns of intelligent antenna array elements 10 and the base station antenna array 2 is composed of a column of four base station antenna array elements 20. The intelligent antenna array and the base station antenna array are vertically separated by a distance in the vertical direction shown in FIG. 1 The antenna is capable of integrating application functions of the intelligent antenna and the conventional base station antenna, implementing the integration of the two type antennas, and reducing the difficulty of network planning as well as the cost.

However, in order to balance the gain, upper sidelobe suppression after the electric downtilt and other indexes, the selection range of the low frequency band radiation array spacing is generally 250 mm˜300 mm, and the selection range of the high frequency band radiation array spacing is generally 105 mm˜115 mm, and the length of the radome is generally limited to 2 m or less, so the number of high frequency antenna array elements and low frequency antenna array elements is limited. When the number of array elements of the array antenna is limited, the antenna gain corresponding to the array antenna is also limited, such that a high-gain multi-system integrated antenna cannot be realized in one radome.

### SUMMARY OF THE INVENTION

The present application aims to provides a multi-system integrated antenna with a high gain at a certain size.

For solving the above-mentioned problem, the present application provides the following technical solutions:

A multi-system integrated antenna, includes: a reflective plate; an intelligent antenna array and a base station antenna array both disposed on the reflective plate; the intelligent antenna array is located at a lower end of the reflective plate, and includes a plurality of intelligent antenna subarrays, each of the intelligent antenna subarrays being composed of a plurality of intelligent antenna array elements; the base station antenna array includes a plurality of first base station antenna array elements and second base station antenna array elements, and the plurality of first base station antenna array elements are located at an upper end of the reflective plate, and the second base station antenna array elements are located at a lower end of the reflective plate and embedded in gaps of the plurality of intelligent antenna array elements, and enclose a plurality of the intelligent antenna array elements of the two adjacent intelligent antenna subarrays therein.

Preferably, the intelligent antenna array comprises four columns of intelligent antenna subarrays which are arranged longitudinally and in parallel.

Preferably, a plurality of intelligent antenna array elements of the two adjacent intelligent antenna subarrays are arranged in parallel or in a misaligned manner.

Preferably, a plurality of intelligent antenna array elements of two adjacent intelligent antenna subarrays enclosed by the second base station antenna array element are arranged in a one-to-one correspondence manner.

Further, the first base station antenna array element and the second base station antenna array element are both low frequency base station antenna array elements, and the base station antenna array further includes a plurality of high frequency base station antenna array elements disposed at a same end of the reflective plate with the plurality of first base station antenna array elements, and the plurality of high frequency base station antenna array elements are longitudinally arranged with the first base station antenna array in parallel, or the plurality of high frequency base station antenna array elements and the first base station antenna array elements are arranged in a column

Preferably, centers of the second base station antenna array element and the first base station antenna array element are not in the same axial direction.

Preferably, the first base station antenna array element and the second base station antenna array element are fed in an unequal phase.

Preferably, the low frequency base station antenna array element operates at 880-960 MHz, the high frequency base station antenna array element operates at 1710-1880 MHz, and the intelligent antenna array operates at 1880-1920 MHz, 2010-2025 MHz and 2575-2635 MHz.

Preferably, the first base station antenna array element and the second base station antenna array element are low frequency base station antenna array elements, and the base station antenna array further includes one or more high frequency base station antenna arrays composed of a plurality of high frequency base station antenna array elements and disposed at a same end of the reflective plate with the plurality of first base station antenna array elements, and the high frequency base station antenna array and the first base station antenna array element are arranged longitudinally and in parallel, or the high frequency base station antenna array is arranged in a column with the first base station antenna array element.

Preferably, a space enclosed by the plurality of intelligent antenna array elements is adjacent to a space required by one of the second base station antenna array elements.

Preferably, a radiation structure of the base station antenna array element is in a ring, a rectangle or a polygon.

Preferably, the intelligent antenna array and the base station antenna array are electrically connected with or capacitively coupled to the reflective plate.

Preferably, the second base station antenna array element is disposed adjacent to the first base station antenna array element.

A multi-system integrated antenna, includes: a reflective plate; and an intelligent antenna array and a base station antenna array both disposed on the reflective plate; the intelligent antenna array is located at a lower end of the reflective plate, and includes a plurality of intelligent antenna subarrays, each of the intelligent antenna subarrays being composed of a plurality of intelligent antenna array elements; the base station antenna array contains a plurality of first base station antenna arrays and a plurality of second base station antenna array elements, and the plurality of first base station antenna arrays are located at an upper end of the reflective plate, the plurality of second base station antenna array elements are located at a lower end of the reflective plate and embedded in gaps of the plurality of intelligent antenna array elements, and enclose the plurality of intelligent antenna array elements of the plurality of non-adjacent intelligent antenna subarrays therein.

Preferably, the first base station antenna arrays and the second base station antenna array element are low frequency base station antenna array elements, and the base station antenna array further includes one or more high frequency base station antenna arrays composed of a plurality of high frequency base station antenna array elements and disposed at a same end of the reflective plate with the plurality of first base station antenna arrays, and the high frequency base station antenna array and the plurality of first base station antenna arrays are arranged longitudinally and in parallel, or the high frequency base station antenna array and the plurality of first base station antenna arrays are arranged in a same column

The solution of the present application possesses the following advantages:

1. The present application sets the intelligent antenna arrays and the base station antenna arrays operating in different frequency bands at different ends of the reflective plate, and the array elements of at least one base station antenna array enclose the array elements of the plurality of intelligent antenna arrays therein. By fully utilizing the gaps between the antenna array elements, one or more base station antenna array elements are added while maintaining the size of the radome and the reflective plate unchanged, thereby increasing the gain of the antenna.

2. In the multi-system integrated antenna of the present application, since the space occupied by the plurality of intelligent antenna array elements is adjacent to the space required by the single base station antenna array element, the design not only may utilize the space reasonably, but also may ensure that the performance of the embedded base station antenna array elements is basically the same as that of the ordinary base station antenna array elements.

3. Since the intelligent antenna array and the base station antenna array of the present application are respectively disposed at different ends of the reflective plate, only a few array elements of the intelligent antenna array are enclosed by the base station antenna array elements adjacent to the intelligent antenna array, and for the intelligent antenna array having a plurality of intelligent antenna array elements, the base station antenna array has less influence on it, such that it is easier to obtain superior performance indexes.

Additional aspects and advantages of the present application will partly be presented in the following description, become apparent in the following description or be appreciated in practicing of the application.

### THE DESCRIPTION OF DRAWINGS

The above and/or additional aspects and advantages of the present application will become apparent and readily understood from the following description of the embodiments with reference to the drawings, wherein:

FIG. 1 is a schematic structural diagram of a multi-system integrated antenna related to a Chinese patent publication CN101465473B;

FIG. 2 is a schematic structural diagram of a multi-system integrated antenna according to Embodiment 1 of the present application;

FIG. 3 is a schematic structural diagram of a multi-system integrated antenna according to Embodiment 2 of the present application;

FIG. 4 is a schematic structural diagram of a multi-system integrated antenna according to Embodiment 3 of the present application;

FIG. 5 is a schematic structural diagram of a multi-system integrated antenna according to Embodiment 4 of the present application;

FIG. 6 is a schematic structural diagram of a multi-system integrated antenna according to Embodiment 5 of the present application;

FIG. 7 is a schematic structural diagram of a multi-system integrated antenna according to Embodiment 6 of the present application; and

FIG. 8 is a schematic structural diagram of a multi-system integrated antenna according to Embodiment 7 of the present application.

### DETAILED DESCRIPTION OF THE PREFERRED EMBODIMENT

Embodiments of the present application will be described in detail hereafter. The examples of these embodiments have been illustrated in the drawings throughout which same or similar reference numerals refer to same or similar elements or elements having same or similar functions. The embodiments described hereafter with reference to the drawings are illustrative, merely used for explaining the present application and should not be regarded as any limitations thereto.

### Embodiment 1

As shown in FIG. 2, the embodiment provides a multi-system integrated antenna, including a reflective plate 3, and an intelligent antenna array 1 and a base station antenna array 2 both disposed on the reflective plate 3. Wherein, the intelligent antenna array 1 and the base station antenna array 2 respectively constitute an intelligent antenna and a base station antenna, thereby realizing that an antenna of different systems (TD-LTE system and conventional cellular mobile system, such as GSM900 MHz and CDMA800 MHz) operating in different frequency bands use a common reflective plate and a radome, and realizing multi-system integrated design, which is beneficial to miniaturization of the antenna and saves installation space.

The reflective plate 3 serves as a common reflector of the intelligent antenna array 1 and the base station antenna array 2. The intelligent antenna array 1 and the base station antenna array 2 are electrically connected with the reflective plate 3, respectively, preferably by conducted electrical connection or capacitive coupling connection.

The intelligent antenna array 1 is located at a lower end of the reflective plate 3, and includes four intelligent antenna subarrays 11, 12, 13, and 14. Each intelligent antenna subarray is consisted of four or more intelligent antenna array elements longitudinally arranged in a same axis. In this embodiment, each intelligent antenna array contains 9 array elements.

The base station antenna array 2 includes at least two first base station antenna array elements 21 and at least one second base station antenna array element 20; the first base station antenna array element 21 is disposed at an upper end of the reflective plate 3, and the second base station antenna array elements 20 are disposed adjacent to the first base station antenna array element 21 and at a lower end of the reflective plate 3, and at least one of the second base station antenna array elements 20 is embedded in the gaps between the intelligent antenna array elements, and encloses each two intelligent antenna array elements of two adjacent intelligent antenna subarrays (i.e., four adjacent intelligent antenna array elements) therein. In the embodiment, one of the second base station antenna array elements 20 encloses four intelligent antenna array elements 121, 122, 131 and 132 of the middle two columns of intelligent antenna subarrays 12 and 13 therein.

With regards to this, a single second base station antenna array element 20 is configured that the required installation space thereof is adjacent to the space occupied by the four intelligent antenna array elements, such that one second base station antenna array element 20 may enclose four intelligent antenna array elements therein.

By disposing the intelligent antenna array 1 and the base station antenna array 2 at different ends of the reflective plate 3, and at least one second base station antenna array element 20 enclosing a plurality of intelligent antenna array elements therein, and by effectively utilizing the gaps between the intelligent antenna array elements, the number of base station antenna array elements is increased without increasing the size of the radome and the reflective plate 3, thereby improving the gain of the base station antenna array, and facilitating the miniaturization design of the antenna.

Since the space occupied by the plurality of intelligent antenna array elements is adjacent to the space required by the single base station antenna array element, the space may be used reasonably and it may also be ensured that the performance of the base station antenna array element (i.e., the second base station antenna array element 20) embedded into the gaps of the intelligent antenna array elements is basically the same as that of the ordinary base station antenna array element (i.e., the first base station antenna array element 21).

In addition, the second base station antenna array element 20 embedded in the gaps of the intelligent antenna arrays 1 is disposed adjacent to the first base station antenna array element 21, which is beneficial to form an array of the base station antennas and ensures that the embedded second base station antenna array element 20 only impacts on two or three antenna array elements in the edge of each intelligent antenna subarray, and has a small impacts on the overall performance of the intelligent antenna array 1 which having more than eight array elements in each intelligent antenna subarray.

In other embodiments, those skilled in the art may configure the second base station antenna array as needed to enclose six or other numbers of intelligent antenna array elements therein.

Preferably, the intelligent antenna array elements of the middle two columns of intelligent antenna subarrays 12 and 13 are arranged in parallel and in a one-to-one correspondence, and the intelligent antenna subarrays 11 and 14 on both sides are arranged in a misaligned manner or in parallel with the intelligent antenna array element of one adjacent intelligent antenna subarrays 12 and 13.

Preferably, the plurality of intelligent antenna array elements of the two adjacent intelligent antenna subarrays enclosed by the second base station antenna array element 20 are arranged in a one-to-one correspondence manner.

In the multi-system integrated antenna of the present application, the second base station antenna array element 20 and the first base station antenna array element 21 are preferably low frequency base station antenna array elements, which have the same radiation structure, and are all in a rectangular form.

As the number of the second base station antenna array elements 20 increases, the impact on the intelligent antenna array 1 is also aggravated. Therefore, those skilled in the art may appropriately set the number of the second base station antenna array elements 20 according to the gain requirements of the base station antenna and the intelligent antenna. In other words, in the embodiment, the number of second base station antenna array elements 20 embedded in the gaps of the plurality of array elements of the intelligent antenna array 1 is not limited to one.

### Embodiment 2

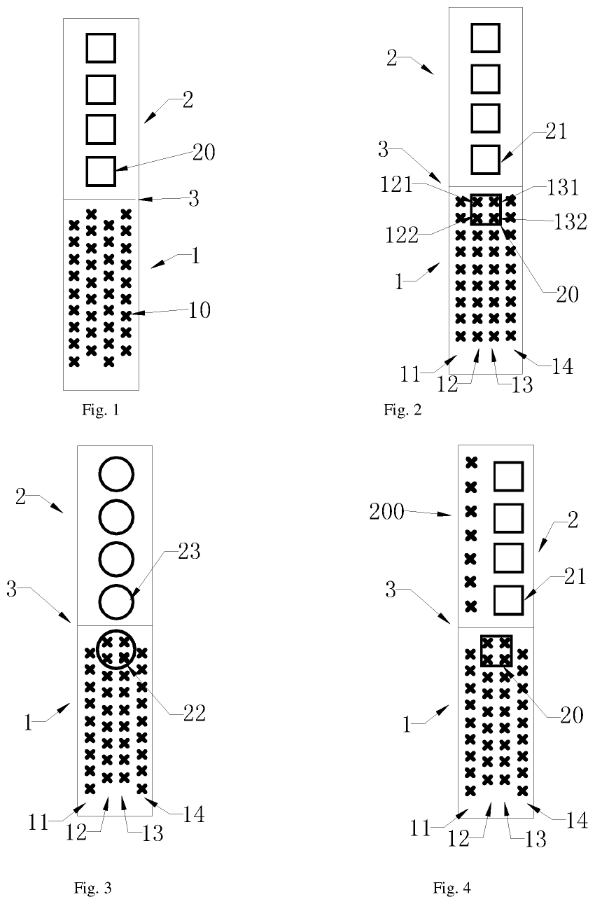

As shown in FIG. 3, the embodiment provides a multi-system integrated antenna, mainly characterized in that the radiation structures of the second base station antenna array element 22 and the first base station antenna array element 23 are in a ring form. The rest parts are consistent with Embodiment 1.

### Embodiment 3

As shown in FIG. 4, the embodiment provides a multi-system integrated antenna, mainly characterized in that the base station antenna is in the form of a multi-frequency shared antenna, that is, the base station antenna array 2 further includes a plurality of high frequency base station antenna array elements 200 disposed on the same side of the reflective plate 3 with the first base station antenna array 21 (low frequency base station antenna array element), and the high frequency base station antenna array element 200 is disposed on the left side of the first base station antenna array element 21. Wherein, the first base station antenna array element 21 and the second base station antenna array element 20 operate at 880-960 MHz, and the high frequency base station antenna array element 200 operates at 1710-1880 MHz, which the two form a dual-frequency shared antenna. The intelligent antenna array operates at 1880-1920 MHz, 2010-2025 MHz, and 2575-2635 MHz. The rest parts are consistent with Embodiment 1.

In the embodiment, the high frequency base station antenna array element 200 is added, and the center points of the first base station antenna array element 21 and the second base station antenna array element 20 are not in the same axial direction. In order not to affect the array formation of the first base station antenna array element 21 and the second base station antenna array element 20, the first base station antenna array element 21 and the second base station antenna array element 20 are fed by an unequal phase, thereby making up for misaligned distribution on the space of the first base station antenna array element 21 and the second base station antenna array element 20.

In other embodiments, the high frequency base station antenna array element 200 may also be disposed on the right side of the first base station antenna array element 21, or the plurality of high frequency base station antenna array elements 200 are arranged in a column with the first base station antenna array element 21.

### Embodiment 4

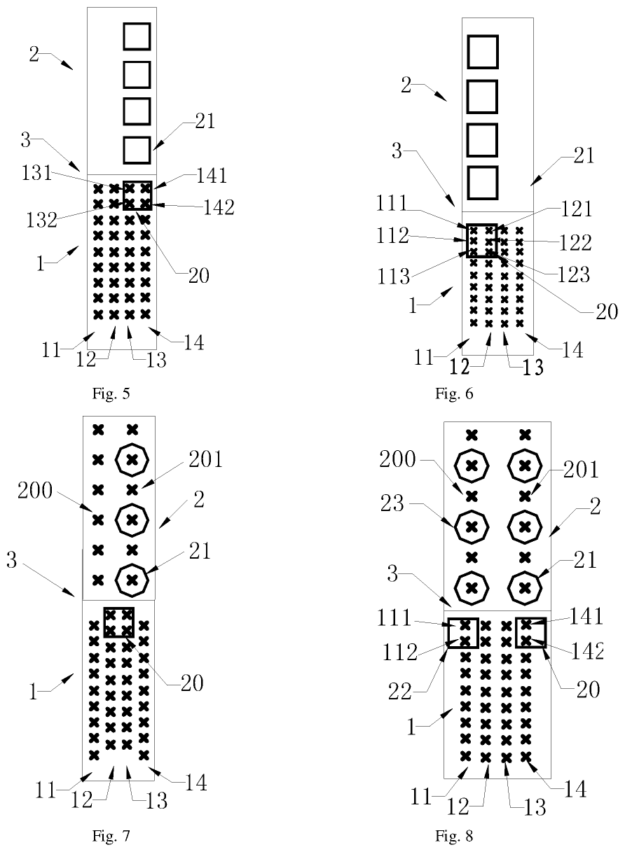

As shown in FIG. 5, the embodiment of the present application provides a multi-system integrated antenna, mainly characterized in that the first base station antenna array element 21 is located on the right side of the reflective plate 3, and the second base station antenna array element 20 is embedded in the gaps of the plurality of array elements of the two right columns of intelligent antenna array elements 13 and 14. The rest parts are consistent with Embodiment 1.

In the embodiment, the second base station antenna array element 20 embeds four adjacent intelligent antenna array elements 131, 132, 141 and 142 therein, and the four adjacent intelligent antenna array elements 131, 132, 141 and 142 are evenly distributed in the two right columns of intelligent antenna subarrays 13 and 14.

### Embodiment 5

As shown in FIG. 6, the embodiment of the present application provides a multi-system integrated antenna, mainly characterized in that the first base station antenna array element 21 is located on the left side of the reflective plate 3, and the second base station antenna array element 20 is embedded in the gaps of the plurality of array elements of the two left columns of intelligent antenna array elements 11 and 12. The rest parts are consistent with Embodiment 1.

In this embodiment, the second base station antenna array element 20 embeds six adjacent intelligent antenna array elements 111, 112, 113, 121, 122 and 123 therein, and six adjacent intelligent antenna array elements 111, 112, 113, 121, 122 and 123 are evenly distributed in the two left columns of intelligent antenna subarrays 11 and 12.

### Embodiment 6

As shown in FIG. 7, the embodiment provides a multi-system integrated antenna, mainly characterized in that the base station antenna is in the form of a multi-frequency shared antenna, and may simultaneously support a dual-channel 900 MHz system, a four-channel 1800 MHz system, and an eight-channel FA\D system, that is, the base station antenna array 2 includes a plurality of high frequency base station antenna array elements 201, which are disposed on the same side of the reflective plate 3 with the first base station antenna array element 21 (low frequency base station antenna element) and at the same axis with the first base station antenna array element 21, and a plurality of high frequency base station antenna array elements 200 disposed on the left side of the first base station antenna array element 21. Wherein, the plurality of high frequency base station array elements 201 constitute a first high frequency base station array operable in a 1710-1880 MHz system. A plurality of high frequency base station elements 200 constitute a second high frequency base station array operable in a 1710-1880 MHz system. A plurality of first base station antenna array elements 21 disposed at the upper end of the reflective plate 3 and at least one second base station antenna array element 20 disposed at the lower end of the reflective plate 3 constitute a first low frequency base station array operable in a 880-960 MHz system. The rest parts are consistent with Embodiment 3. In the embodiment, the first base station antenna array element is disposed on the left side or the right side of the upper end of the reflective plate, and the effects thereof are substantially the same.

### Embodiment 7

As shown in FIG. 8, the embodiment provides a multi-system integrated antenna, mainly characterized in that the base station antenna is in the form of a multi-frequency shared antenna, and may simultaneously support a four-channel 900 MHz system, a four-channel 1800 MHz system, and an eight-channel FA\D system, that is, the base station antenna array 2 is composed of a plurality of first base station antenna array elements 23 disposed on the left side of the upper end of the reflective plate 3 and at least one first base station antenna array element 22 disposed on the left side of the lower end of the reflective plate 3 as a first low frequency base station array operable in a 880-960 MHz system. A plurality of first base station antenna array elements 21 disposed on the right side of the upper end of the reflective plate 3 and at least one first base station antenna array element 20 disposed on the right side of the lower end of the reflective plate 3 constitute a second low frequency base station array operable in the 880-960 MHz system. A plurality of high frequency base station antenna array elements 200 disposed on the same axis with the first base station antenna array element 23 constitute a first high frequency base station antenna array operable in a 1710-1880 MHz system. A plurality of high frequency base station antenna array elements 201 disposed on the same axis with the first base station antenna array element 21 constitute a second high frequency base station antenna array operable in a 1710-1880 MHz system, and the rest parts are consistent with Embodiment 6.

In this embodiment, the second base station antenna array element 20 embeds two adjacent intelligent antenna array elements 141 and 142 therein, and the second base station antenna array element 22 embeds two adjacent intelligent antenna array elements 111 and 112 therein, and the two adjacent intelligent antenna array elements 141 and 142 are distributed in the intelligent antenna subarray 14, and the two adjacent intelligent antenna array elements 111 and 112 are distributed in the intelligent antenna subarray 11.

In all the above embodiments, the first base station antenna array element is disposed on the left side or the right side of the upper end of the reflective plate, and the effects are substantially the same.

The foregoing is only a part of the embodiments of the present application, and it should be noted that those skilled in the art may also make several improvements and retouching without departing from the principles of the present application, which should be considered in the protection scope of the present application.

What is claimed is:

1. A multi-system integrated antenna, comprising: a reflective plate; an intelligent antenna array and a base station antenna array which are both disposed on the reflective plate;
the intelligent antenna array is located at a lower end of the reflective plate, and comprises multiple intelligent antenna subarrays, each of the intelligent antenna subarrays being composed of a plurality of intelligent antenna array elements;
the base station antenna array comprises a plurality of first base station antenna array elements and a plurality of second base station antenna array elements, wherein the plurality of first base station antenna array elements are located at an upper end of the reflective plate, and the second base station antenna array elements are located at a lower end of the reflective plate and embedded in gaps of the plurality of intelligent antenna array elements, and encloses the plurality of intelligent antenna array elements of the two adjacent intelligent antenna subarrays therein.

2. The multi-system integrated antenna according to claim 1, wherein the intelligent antenna array contains four columns of intelligent antenna subarrays which are arranged longitudinally and in parallel.

3. The multi-system integrated antenna according to claim 2, wherein the plurality of intelligent antenna array elements of the two adjacent intelligent antenna subarrays are arranged in parallel or in a misaligned manner

4. The multi-system integrated antenna according to claim 1, wherein a plurality of intelligent antenna array elements of two adjacent intelligent antenna subarrays enclosed by the second base station antenna array element are arranged in a one-to-one correspondence manner.

5. The multi-system integrated antenna according to claim 1, wherein the first base station antenna array element and the second base station antenna array element are both low frequency base station antenna array elements, and the base station antenna array further comprises a plurality of high frequency base station antenna array elements disposed at the same end of the reflective plate with the plurality of first base station antenna array elements, and the plurality of high frequency base station antenna array elements are longitudinally arranged with the plurality of first base station antenna array elements in parallel, or the plurality of high frequency base station antenna array elements are arranged on a same axis with the first base station antenna array elements.

6. The multi-system integrated antenna according to claim 5, wherein centers of the second base station antenna array element and the first base station antenna array element are not in a same axial direction.

7. The multi-system integrated antenna according to claim 6, wherein the first base station antenna array element and the second base station antenna array element are fed in an unequal phase.

8. The multi-system integrated antenna according to claim 5, wherein the low frequency base station antenna array element operates at 880-960 MHz, the high frequency base station antenna array element operates at 1710-1880 MHz, and the intelligent antenna array operates at 1880-1920 MHz, 2010-2025 MHz and 2575-2635 MHz.

9. The multi-system integrated antenna according to claim 1, wherein the first base station antenna array element and the second base station antenna array element are low frequency base station antenna array elements, and the base station antenna array further comprises one or more high frequency base station antenna arrays composed of a plurality of high frequency base station antenna array elements and disposed at a same end of the reflective plate with the plurality of first base station antenna array elements, and the high frequency base station antenna array and the plurality of first base station antenna array elements are arranged longitudinally and in parallel, or the high frequency base station antenna array and the plurality of first base station antenna array elements are arranged on a same axis.

10. The multi-system integrated antenna according to claim 1, wherein a space enclosed by the plurality of intelligent antenna array elements is adjacent to a space required by one of the second base station antenna array elements.

11. The multi-system integrated antenna according to claim 1, wherein a radiation structure of the base station antenna array element is in a ring, a rectangle or a polygon.

12. The multi-system integrated antenna according to claim 1, wherein the intelligent antenna array and the base station antenna array are electrically connected with or capacitively coupled to the reflective plate.

13. The multi-system constellation antenna according to claim 1, wherein the second base station antenna array element is disposed adjacent to the first base station antenna array element.

14. A multi-system integrated antenna, comprising: a reflective plate; and an intelligent antenna array and a base station antenna array which are both disposed on the reflective plate;
the intelligent antenna array is located at a lower end of the reflective plate, and includes a plurality of intelligent antenna subarrays, each of the intelligent antenna subarrays being composed of a plurality of intelligent antenna array elements;
the base station antenna array contains a plurality of base station antenna subarrays, the base station antenna subarray comprises a plurality of first base station antenna array elements and a plurality of second base station antenna array elements, and the plurality of first base station antenna array elements are located at an upper end of the reflective plate, the plurality of second base station antenna array elements are located at a lower end of the reflective plate and embedded in gaps of the plurality of intelligent antenna array elements, and enclose the plurality of intelligent antenna array elements of the plurality of non-adjacent intelligent antenna subarrays therein.

15. The multi-system integrated antenna according to claim 14, wherein the first base station antenna array element and the second base station antenna array element are low frequency base station antenna array elements, and the base station antenna array further comprises one or more high frequency base station antenna arrays composed of a plurality of high frequency base station antenna array elements and disposed at a same end of the reflective plate with the plurality of first base station antenna array elements, and the high frequency base station antenna array and the plurality of first base station antenna array elements are arranged longitudinally and in parallel, or the high frequency base station antenna array and the plurality of first base station antenna array elements are arranged on a same axis.
